(19) United States
(12) Patent Application Publication
(10) Pub. No.: US 2026/0292868 A1
(43) Pub. Date: Sep. 24, 2026

(54) METHODS, ARCHITECTURES, APPARATUSES AND SYSTEMS FOR TRANSMISSION SCHEME SELECTION

(71) Applicant: InterDigital Patent Holdings, Inc., Wilmington, DE (US)

(72) Inventors: Jongwoo Hong, New York, NY (US); Martino Freda, Laval (CA); Paul Marinier, Brossard (CA); Erdem Bala, East Meadow, NY (US); Kevin Wanuga, Souderton, PA (US); Patrick Tooher, Montreal (CA)

(21) Appl. No.: 19/088,217

(22) Filed: Mar. 24, 2025

(51) Int. Cl. H04W 74/00

(52) U.S. Cl. CPC H04W 74/002

(57) ABSTRACT

A wireless transmit/receive unit (WTRU) may receive configuration information associated with a set of transmission schemes. The configuration information may include threshold information. The WTRU may receive paging information indicating a set of devices and/or transmission schemes. The WTRU may send, based on the paging information, a first R2D message which includes information indicating the devices. The WTRU may receive one or more D2R messages which include information indicating one or more of the devices. The WTRU may determine to apply a first or second transmission scheme of the set of transmission schemes based on at least one condition being satisfied. The WTRU may send a second R2D message which includes information indicating the at least one of the devices and the determined transmission scheme.

### BACKGROUND

The present application is related to the fields of communications, software and encoding, including, for example, to methods, architectures, apparatuses, systems directed to procedures for selection of transmission schemes, such as feedback schemes and retransmission schemes.

According to a study item description (SID), 3GPP plans to study Ambient Internet of Things (IoT). In recent years, IoT has attracted much attention in the wireless communication world. More ‘things’ are expected to be interconnected for improving productivity, efficiency, and increasing comforts of life. Further reductions of size, complexity, and power consumption of IoT devices may enable the deployment of tens or even hundreds of billion IoT devices for various applications and provide added value across the entire value chain. It is likely impossible to power all IoT devices by battery due to the need for manual battery replacement and/or recharging, which leads to high maintenance costs, serious environmental issues, and even safety hazards for some use cases (e.g., wireless sensors in electric power and petroleum industries).

Most existing wireless communication devices are powered by a battery that needs to be replaced or recharged manually. The automation and digitalization of various industries opens a number of new markets requiring new IoT technologies of supporting battery-less devices with no energy storage capability or devices with energy storage that does not need to be replaced or recharged manually. In many instances, the form factor of such devices must be reasonably small to satisfy the validity of target use cases.

As an example use case, 3GPP TR 22.840 describes asset identification, which presently has to resort mainly to barcode and RFID tags in most industries. The main advantage of these two technologies is the ultra-low complexity and small form factor of the tags. However, the limited reading range of a few meters usually requires handheld scanning which leads to labor intensive and time-consuming operations, and/or RFID portals or gates which leads to costly deployments. Moreover, the lack of an interference management scheme can result in severe interference between RFID readers and capacity problems, especially in case of dense deployments. It is hard to support large-scale networks with seamless coverage for RFID.

The RAN 2 scope of the work for this SID includes to study and decide which functions are needed for an Ambient IoT compact protocol stack and lightweight signalling procedure to enable DO-DTT and DT data transmission, and study those functions. For example, paging, random access, data transmission, including necessary radio resource control aspects, respecting the limitation in the general scope, and interactions with upper layers. For functionalities not listed above, they are planned to be studied only if found essential.

It would be beneficial to provide procedures for transmission scheme selection, such as to provide reliability and/or simplicity on an as-needed basis (e.g., dependent on current conditions) for Ambient IoT devices.

### BRIEF SUMMARY

Briefly stated, in one embodiment, a wireless transmit/receive unit (WTRU) may receive configuration information associated with a set of transmission schemes. The configuration information may include threshold information. The WTRU may receive paging information indicating a set of devices and/or transmission schemes. The WTRU may send, based on the paging information, a first R2D message which includes information indicating the devices. The WTRU may receive one or more D2R messages which include information indicating one or more of the devices. The WTRU may determine to apply a first or second transmission scheme of the set of transmission schemes based on at least one condition being satisfied. The WTRU may send a second R2D message which includes information indicating the at least one of the devices and the determined transmission scheme.

In another embodiment, a WTRU 102 may receive an AIoT configuration associated with transmission schemes (e.g., selection of a transmission scheme for feedback and/or retransmission). The configuration information may include information indicating one or more conditions for transmission scheme selection. The configuration information may include information indicating a D2R message size. The configuration information may include information indicating one or more feedback transmission schemes. The configuration information may include information indicating one or more retransmission schemes. The WTRU may send a first transmission (e.g., for triggering random access) to one or more devices upon receiving a paging message for the one or more devices. The WTRU may receive one or more second transmissions from the one or more devices. The WTRU may determine a transmission scheme applicable to the one or more devices based on at least one of the conditions being satisfied. The WTRU may send a third transmission to the one or more devices that includes information indicating the determined transmission scheme.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example communications system, according to one or more embodiments of the present disclosure;

FIG. 1B is a system diagram illustrating an example wireless transmit/receive unit (WTRU) that may be used within the communications system illustrated in FIG. 1A, according to one or more embodiments of the present disclosure;

FIG. 1C is a system diagram illustrating an example radio access network (RAN) and an example core network (CN) that may be used within the communications system illustrated in FIG. 1A, according to one or more embodiments of the present disclosure;

FIG. 1D is a system diagram illustrating a further example RAN and a further example CN that may be used within the communications system illustrated in FIG. 1A, according to one or more embodiments of the present disclosure;

FIG. 2 is a signaling diagram illustrating the steps for an RFID inventory procedure between an interrogator and a single tag, according to one or more embodiments of the present disclosure;

FIG. 3A is a topology diagram illustrating an example of a first topology, according to one or more embodiments of the present disclosure;

FIG. 3B is a topology diagram illustrating an example of a second topology, according to one or more embodiments of the present disclosure;

FIG. 3C is a topology diagram illustrating an example of a third topology with downlink assistance, according to one or more embodiments of the present disclosure;

FIG. 3D is a topology diagram illustrating an example of a fourth topology with uplink assistance, according to one or more embodiments of the present disclosure;

FIG. 3E is a topology diagram illustrating an example of a fifth topology, according to one or more embodiments of the present disclosure;

FIG. 4 is a signalling diagram illustrating an example of a re-access operation via an explicit feedback indication to a WTRU, according to one or more embodiments of the present disclosure;

FIG. 5 is a signalling diagram illustrating an example of an ACK-based scheme via an explicit feedback indication to a WTRU, according to one or more embodiments of the present disclosure;

FIG. 6 is an offset-based scheme diagram illustrating an example grant for D2R data, according to one or more embodiments of the present disclosure;

FIG. 7 is a signaling diagram illustrating an example of a NDI-based scheme, according to one or more embodiments of the present disclosure;

FIG. 8 is a signaling diagram illustrating an example of a NACK-based scheme where NACK reception is unsuccessful, according to one or more embodiments of the present disclosure;

FIG. 9 is a flow diagram illustrating an example flow to configure a device with a feedback scheme and a retransmission scheme, according to one or more embodiments of the present disclosure;

FIG. 10 is a signaling diagram illustrating an example where NACK feedback has failed, according to one or more embodiments of the present disclosure;

FIG. 11 is a procedural diagram illustrating an example procedure for determining a transmission scheme for one or more devices, according to one or more embodiments of the present disclosure; and

FIG. 12 is a procedural diagram illustrating another example procedure for determining a transmission scheme for one or more devices, according to one or more embodiments of the present disclosure.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

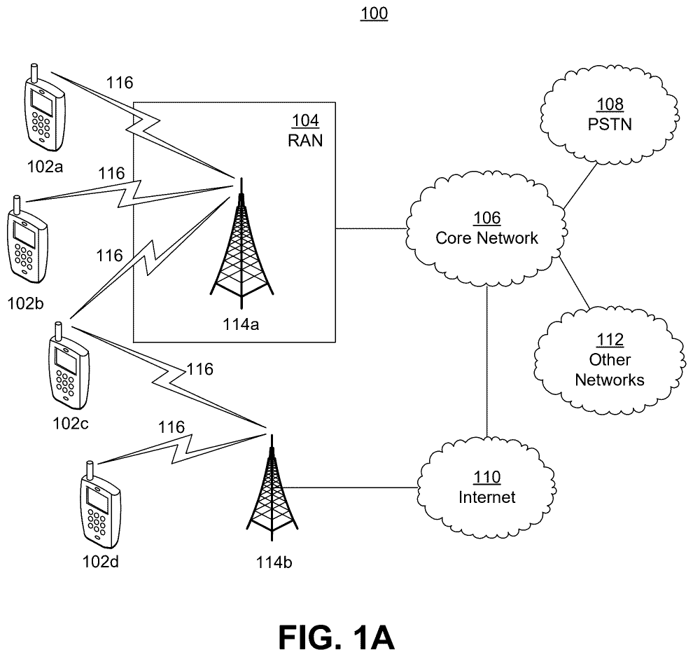

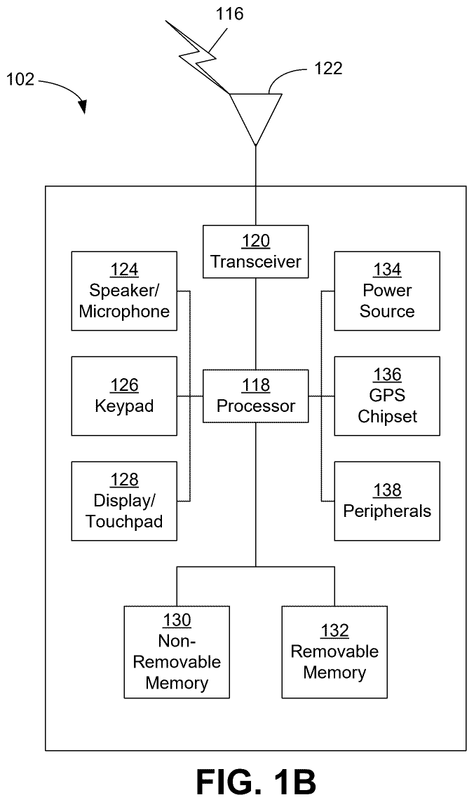

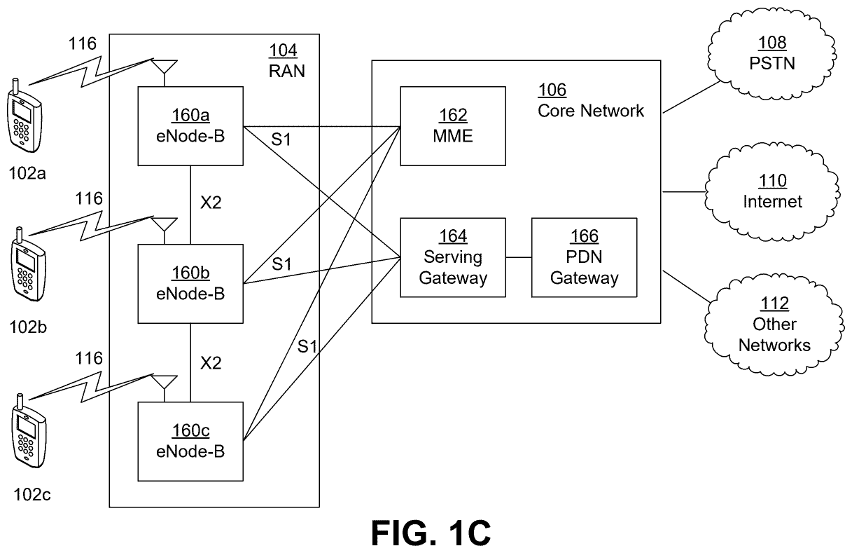

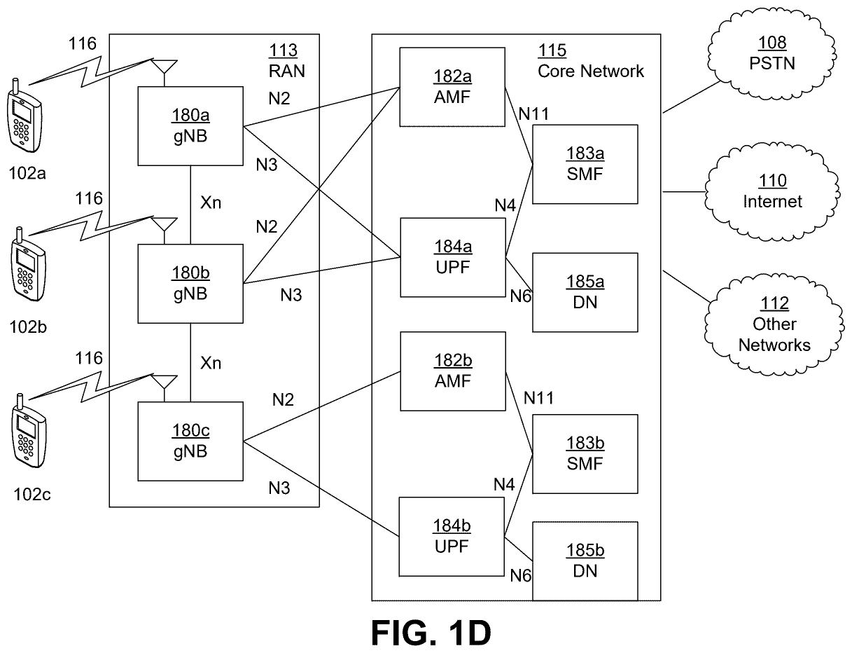

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

The following abbreviations and acronyms may be used throughout the disclosure:
ACK Acknowledgement
AIoT Ambient IoT
AIoT AF A-IoT application server
AIoTF Ambient A-IoT function
AMF Access and Mobility management Function
AS Access-Stratum
BSR Buffer Status Report
BWP Bandwidth Part
CCE Control Channel Element
CE Control Element
CG Configured Grant
CN Core Network
CW Contention Window
CWS Contention Window Size
CW Carrier Wave
DCI Downlink Control Information
DG Dynamic grant
DL Downlink
DO-DTT Device Originated Device Terminated Triggered
DRB Data Radio Bearer
DT Device Terminated
D2R Device to Reader
EPC Electronic product code
HARQ Hybrid Automatic Repeat Request
IoT Internet of Things
LMF Location Management Function
LTE Long Term Evolution e.g. from 3GPP LTE R8 and up
NACK Negative ACK
NAS Non-Access-Stratum
NEF Network Exposure Function
NGAP NG Application Protocol
MAC Media Access Control
MAC CE MAC Control Element
MCS Modulation and Coding Scheme
NDI New Data Indicator
NR New Radio
NRF Network Repository Function
OFDM Orthogonal Frequency-Division Multiplexing
PDB Packet Delay Budget
PDU Packet Data Unit
PHY Physical Layer
PO Paging Occasion
PRACH Physical Random Access Channel
PSS Primary Synchronization Signal
QoS Quality of Service
RA Random Access (or procedure)
RACH Random Access Channel
RAR Random Access Response
RCU Radio access network Central Unit
RF Radio Front end
RFID Radio Frequency Identification
RNTI Radio Network Identifier
RO RACH occasion
RRC Radio Resource Control
RSRP Reference Signal Received Power
RSRQ Reference Signal Received Quality
RSSI Received Signal Strength Indicator
R2D Reader to Device
SDU Service Data Unit
SIB System Information Block
SR Scheduling Request
SRB Signaling Radio bearer
SRS Sounding Reference Signal
SS Synchronization Signal
SSB Synchronization Signal Block
SSS Secondary Synchronization Signal
SWG Switching Gap (in a self-contained subframe)
SPS Semi-persistent scheduling
PC Protocol Control
TB Transport Block
TID Tag-identification or Tag identifier
TBS Transport Block Size
UCI User Control Information
UDM Unified Data Management
UDR Unified Data Repository
UPF User Plane Function
UL Uplink
XPC Extended Protocol Control
RFID

In the RFID specification, EPC Radio-Frequency Identity Protocols Generation-2 UHF RFID, a procedure is provided in which an interrogator inventories and accesses a single tag.

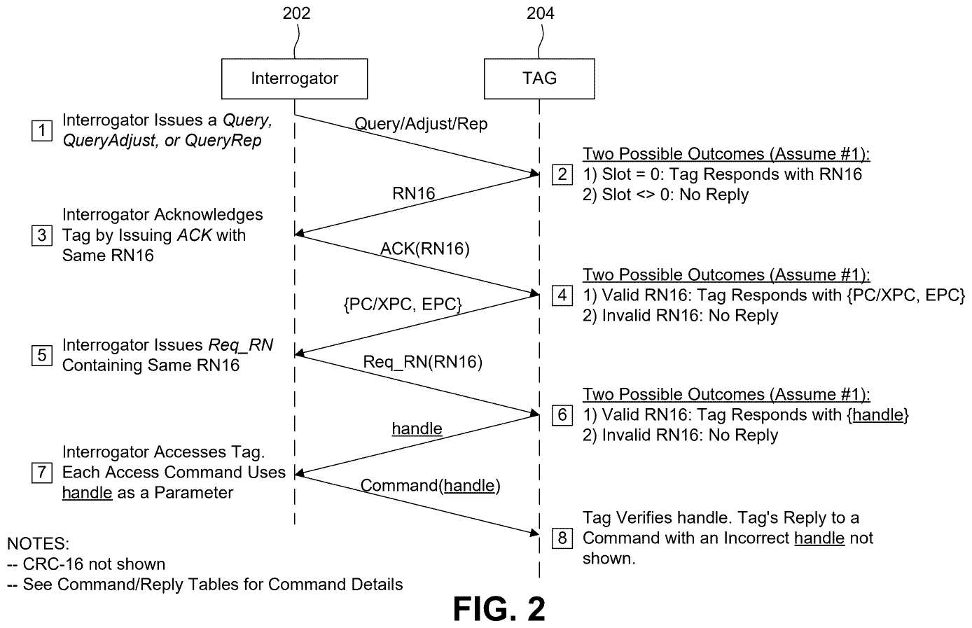

FIG. 2 is a signaling diagram illustrating the steps for an RFID inventory procedure between an interrogator 202 and a single tag 204, according to one or more embodiments of the present disclosure. As shown in FIG. 2, a query message (e.g., Query, QueryAdjust, or QueryRep) at step 1 from the interrogator 202 initiates one round of the inventory procedure, and the query message including a parameter Q, which is used by the interrogator 202 to regulate the probability of a response from the tag 204. Upon receiving the query message, the tag 202 may select its slot counter to a value between 0 and 2\hat{ }Q-1 derived from the parameter Q. Then the tag 204 may decrement their slot counter every time upon receiving a QueryRep. When the tag 204 has its slot counter reaches zero, at step 2, the tag 204 may transmit a 16 bit random number (RN16). On condition that the slot counter equals 0, the tag 204 sends an RN16 message to the interrogator 202. If the slot counter does not equal 0, the tag 204 does not send the RN16 message (i.e., does not reply to the interrogator 202). In response to the RN16 message, at step 3, the interrogator 202 acknowledges receiving the RN16 message by sending an acknowledgement (ACK), including the same RN16 received from the tag 204. On condition that the ACK at step 3 includes a valid RN16 (e.g., the same RN16 generated/transmitted by the tag at step 2), at step 4, the tag 204 sends a protocol control (PC) or extended protocol control (XPC), electronic product code (EPC) message. In one example, upon receiving the valid RN16, the tag 204 may transmit the tag's unique identity information (e.g., PC/XPC, EPC). Otherwise, on condition that the ACK does not include a valid RN16 (e.g., not the same RN16 generated/transmitted by the tag 204 in step 2), the tag 204 does not send the PC/XPC, EPC message (e.g., does not reply to interrogator 202 at step 4). In response to receiving the PC/XPC, EPC message, at step 5, the interrogator 202 sends a Req_RN message to the tag 204 (e.g., to check the successful reception of the PC/XPC EPC message from step 4), including the same RN16 as in the RN16 message from step 2 and ACK from step 3. On condition that the Req_RN message includes a valid RN16, at step 6, the tag 204 sends a handle to interrogator 202. Otherwise, on condition that the Req_RN message from step 5 does not include a valid RN16, the tag 204 does not send a handle to the interrogator 202 (e.g., does not reply to the interrogator 202). After receiving the handle, at step 7, the interrogator 202 has access to the tag 204, and can issue commands using the handle as a parameter. As shown in step 7, the interrogator 202 sends a command message to the tag 204, which includes the handle as a parameter. In step 8, the tag 204 verifies the handle before accepting the command.

In some implementations, functions for an A-IoT compact protocol stack and lightweight signalling procedure may be provided to enable DO-DTT and DT data transmission. In some implementations, this may include paging, random access, data transmission (e.g., including necessary radio resource control aspects), and/or interactions with upper layers.

### A-IoT Topologies

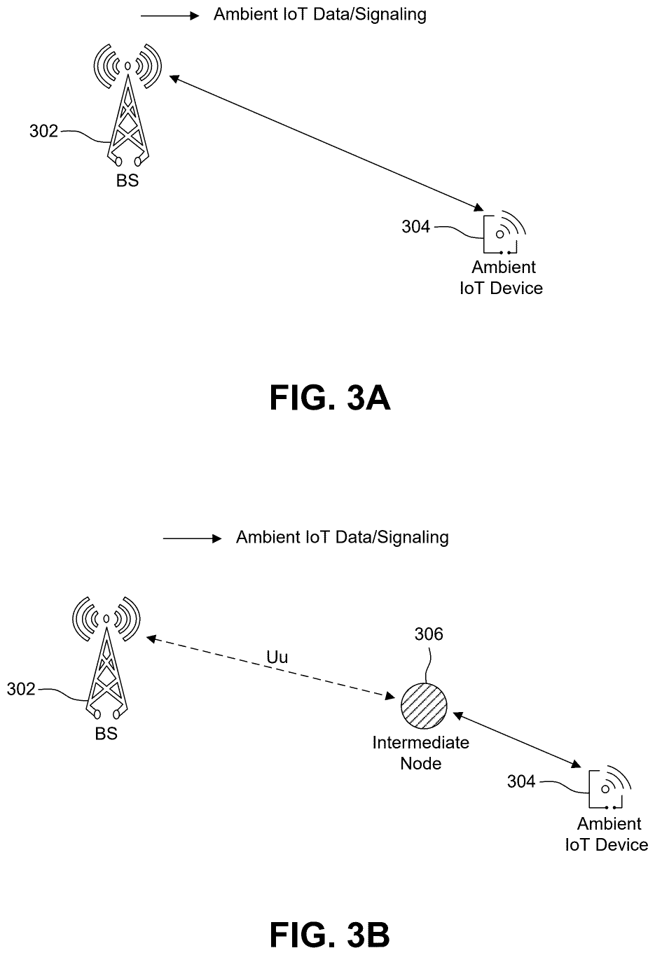

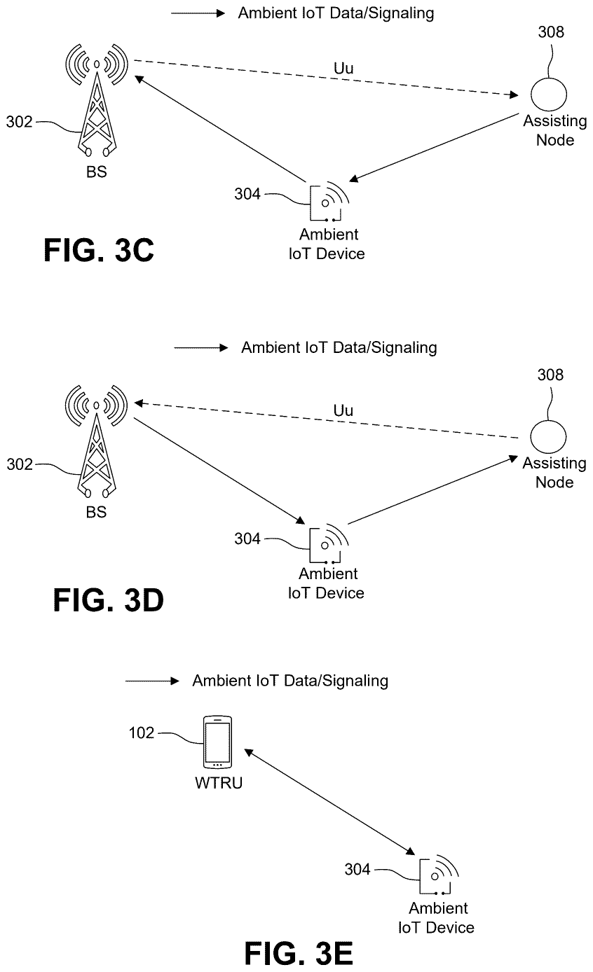

FIG. 3A is a topology diagram illustrating an example of a first topology, according to one or more embodiments of the present disclosure. As shown in FIG. 3A, a base station 302 (e.g., gNB 180 or other transmission/reception point (TRP)) may communicate with an ambient IoT device 304. For example, in FIG. 3A, the ambient IoT device 304 may directly and bidirectionally communicate with the base station 302. The communication between the base station 302 and the ambient IoT device 304 may include Ambient IoT data and/or signalling. This topology may include implementations where the base station 302 transmitting to the Ambient IoT device 304 is a different from the base station 302 receiving from the Ambient IoT device 304.

FIG. 3B is a topology diagram illustrating an example of a second topology, according to one or more embodiments of the present disclosure. As shown in FIG. 3B, a base station 302 (e.g., gNB 180 or other TRP) may communicate with an ambient IoT device 304 via an intermediate node 306. For example, in FIG. 3B, the Ambient IoT device 304 may communicate bidirectionally with the intermediate node 306 between the Ambient IoT device 304 and the base station 302. In this topology, the intermediate node may be be a relay, IAB node, a WTRU 102, a repeater, or the like which is capable of Ambient IoT communication. The intermediate node transfers information between the base station 302 and the Ambient IoT device 304.

FIG. 3C is a topology diagram illustrating an example of a third topology with downlink assistance, according to one or more embodiments of the present disclosure. As shown in FIG. 3C, a base station 302 (e.g., gNB 180 or other TRP) may directly communicate in the uplink direction with an ambient IoT device 304 and in the downlink direction via an assisting node 308 using the Uu interface.

FIG. 3D is a topology diagram illustrating an example of a fourth topology with uplink assistance, according to one or more embodiments of the present disclosure. As shown in FIG. 3D, a base station 302 (e.g., gNB 180 or other TRP) may communicate in the downlink direction with an ambient IoT device 304 and in the uplink direction via an assisting node 308 using the Uu interface.

In FIG. 3C, the Ambient IoT device 304 may transmit data and/or signalling to a base station 302, and may receive data and/or signalling from the assisting node 308. In FIG. 3D, the Ambient IoT device 304 may receive data and/or signalling from a base station 302 and may transmit data and/or signalling to the assisting node 308. For example, the assisting node 308 may be a relay, IAB, WTRU 102, repeater, or the like which is capable of ambient IoT communication.

FIG. 3E is a topology diagram illustrating an example of a fifth topology, according to one or more embodiments of the present disclosure. As shown in FIG. 3E, an Ambient IoT device 304 may communicate bidirectionally with a WTRU 102. The communication between the WTRU 102 and the ambient IoT device 304 may include Ambient IoT data and/or signalling.

### Feedback Schemes for D2R Messages

As an example, the second topology may be implemented with one or more WTRUs (e.g., as readers) performing A-IoT operations (e.g., inventory and/or command) with multiple A-IoT devices. For example, a WTRU 102 may receive D2R message(s) from devices and may respond with an explicit a 1-bit indication (e.g., ACK or NACK) for device(s), if the WTRU 102 does not receive a D2R message (e.g., MSG3, or Message 3, and/or D2R data and/or D2R command response).

In some embodiments, according to a NACK-based scheme, if a WTRU 102 does not receive a MSG3 (e.g., upper layer ID) from a device, the WTRU 102 may send explicit feedback (e.g., NACK) for performing re-access.

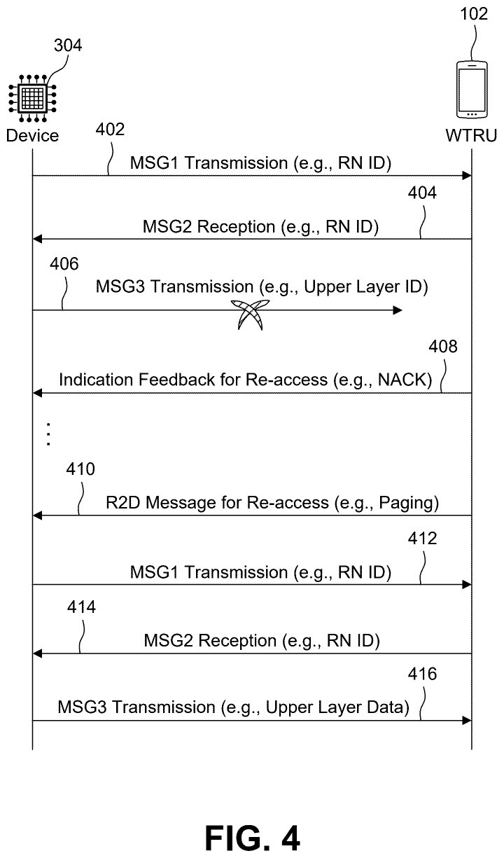

FIG. 4 is a signalling diagram illustrating an example of a re-access operation via an explicit feedback indication to a WTRU 102, according to one or more embodiments of the present disclosure. As shown in FIG. 4, a WTRU 102 may receive a MSG1 transmission (e.g., indicating a RN ID) from a (e.g., AIoT) device at 402. At 404, the WTRU 102 may send a MSG2 (e.g., indicating the RN ID) to the device. At 406, the WTRU 102 may not receive a MSG3 transmission (e.g., indicating an upper layer ID) from the device. At 408, the WTRU 102 may send a feedback indication (e.g., NACK) for re-access to the device. At 410, the WTRU 102 may send a R2D message for re-access (e.g., paging information) to the device. At 412, the WTRU 102 may receive a MSG1 transmission (e.g., indicating the RN ID) from the device. At 414, the WTRU 102 may send a MSG2 (e.g., indicating the RN ID) to the device. At 416, the WTRU 102 may receive a MSG3 transmission (e.g., indicating the upper layer ID) from the device.

For example, after receiving the explicit indication at 508, the device may perform a re-access operation (e.g., triggering new RACH procedure) upon receiving the subsequent paging information at 510. Moreover, if the device does not receive any feedback upon transmitting the D2R message (e.g., MSG3) during a (e.g., predefined or preconfigured) time duration, then the device can determine (e.g., assume) that the transmission of the D2R message (e.g., MSG3) is successful.

In some embodiments, according to an ACK-based scheme, if a WTRU 102 receives a MSG3 (e.g., upper layer ID) from a device, the WTRU 102 may (e.g., always) send explicit feedback (e.g., ACK) for a confirmation of reception MSG3.

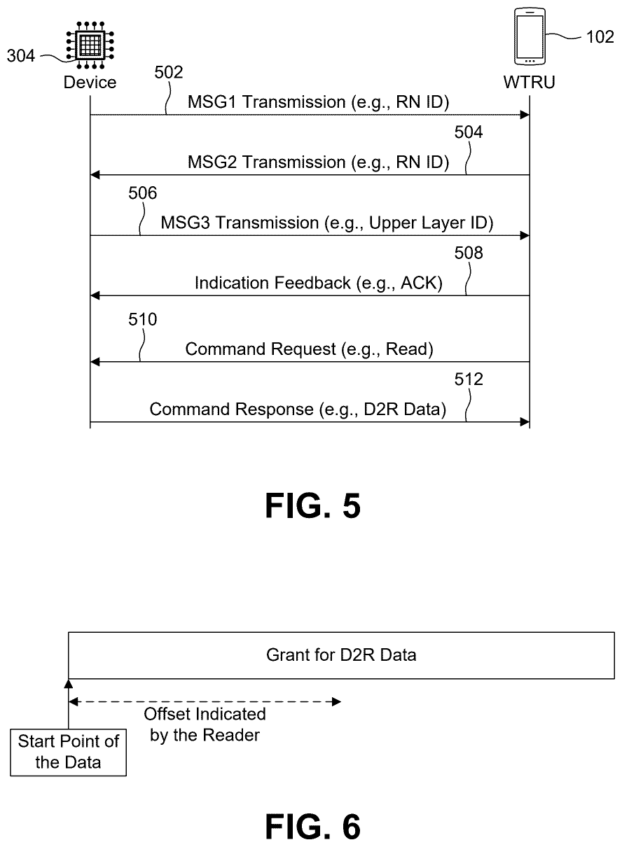

FIG. 5 is a signalling diagram illustrating an example of an ACK-based scheme via an explicit feedback indication to a WTRU 102, according to one or more embodiments of the present disclosure. As shown in FIG. 5, a WTRU 102 may receive a MSG1 transmission (e.g., indicating a RN ID) from a (e.g., AIoT) device 304 at 502. At 504, the WTRU 102 may send a MSG2 (e.g., indicating the RN ID) to the device 304. At 506, the WTRU 102 may receive a MSG3 transmission (e.g., indicating an upper layer ID) from the device 304. At 508, the WTRU 102 may send a feedback indication (e.g., ACK) to the device 304. At 510, the WTRU 102 may send a command request (e.g., read) to the device 304. At 512, the WTRU 102 may receive a command response (e.g., D2R data) from the device 304.

For example, after receiving the explicit indication at 508, the device may determine an inventory procedure is completed (e.g., if the device is triggered for an inventory procedure only) or the device may perform a command procedure (e.g., if the device is triggered for an inventory and command procedure).

Retransmission Schemes for Segmented D2R Data

For example, in the second topology, the WTRU 102 may (e.g., be configured to) perform segmented D2R data transmission and request to retransmit for segmented D2R data transmissions with D2R messages. For segmented D2R message transmissions, the WTRU 102 may configure and request to retransmit the segmented data using an offset-based scheme or a New Data Indicator-based (NDI-based) scheme.

FIG. 6 is an offset-based scheme diagram illustrating an example grant for D2R data, according to one or more embodiments of the present disclosure. As shown in FIG. 6, a WTRU 102 (e.g., reader) may request a retransmission of segmented D2R data with a D2R grant (e.g., for D2R data). The WTRU 102 may (e.g., also) indicate (e.g., explicitly) an offset of how many bits have been successfully received so far. The WTRU 102 may add an offset indication when requesting a retransmission. A device 304 may not need to store (e.g., manage) how many times segmented D2R data has been transmitted successfully and may not need to store a corresponding value (e.g., a NDI value).

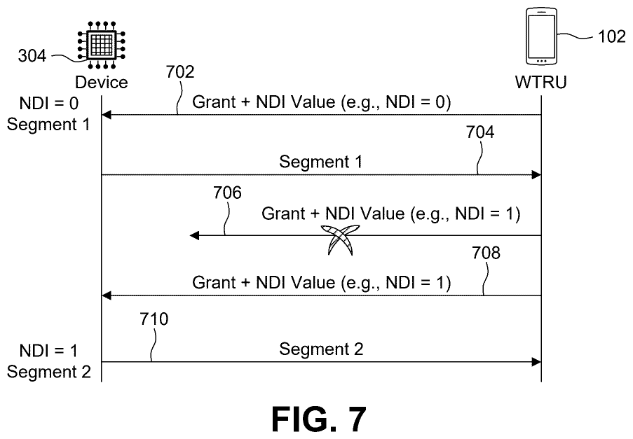

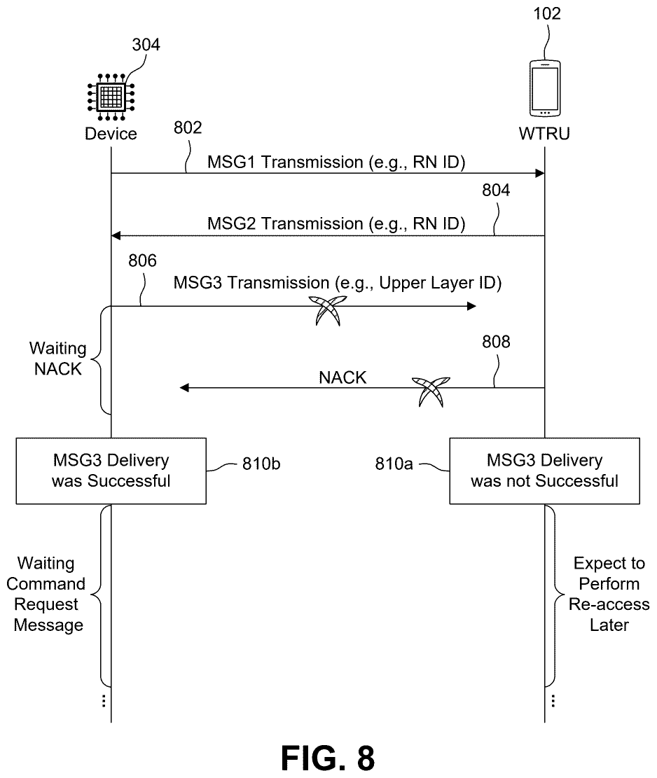

FIG. 7 is a signaling diagram illustrating an example of a NDI-based scheme, according to one or more embodiments of the present disclosure. As shown in FIG. 8, a WTRU 102 may send information indicating a grant and a NDI value (e.g., NDI=0) to a device 304 at 702. At 704, the WTRU 102 may receive a segment of D2R data (e.g., Segment 1) from the device 304. The WTRU 102 may toggle the NDI value (e.g., NDI=1) upon detecting a successful reception of the D2R message at 704. At 706, the WTRU 102 may send information indicating a new grant and the toggled NDI value (e.g., NDI=1). At 708, the WTRU 102 may again send information indicating a new grant and the toggled NDI value (e.g., NDI=1) to the device 304. Also, the device 304 may toggle the NDI value (e.g., NDI=1) upon receiving the new grant with the toggled NDI value (e.g., NDI=1) from the WTRU 102 at 708. At 710, the device 304 may send a next segment (e.g., Segment 2) to the WTRU 102. This NDI-based scheme can achieve reliability for retransmission for D2R (re-)transmissions since the device 304 and WTRU 102 may know and synchronize whether each of the segmented D2R transmissions is received successfully or not. However, there is some overhead for a message that 1-bit NDI information is needed in each of the R2D grants as well as the device needs to manage (e.g., remember) the previous NDI value (e.g., whether 0 or 1) and needs to toggle the stored value, such as if a condition (e.g., successful D2R transmission) is satisfied.

For example, when a WTRU 102 (e.g., reader) selects and configures an ACK-based scheme (e.g., MSG failure) or a NDI-based scheme (e.g., retransmission for segmented D2R data) to a device, reliability of delivery may be increased. However, signaling overhead and energy consumption may be increased since a reader may (e.g., always) send a response to a device. In contrast, in the case of a NACK-based scheme, signaling overhead may be smaller because the reader does not need to respond upon receiving the MSG3 successfully. However, when the NACK delivery fails, the device may misunderstand that the MSG3 was delivered successfully. Due to a trade-off between schemes for reliability and schemes for simplicity, solutions are descried herein for a WTRU 102 (e.g., reader) to configure schemes (e.g., ACK-based, NDI-based) to achieve reliability, such as based on observed conditions.

FIG. 8 is a signaling diagram illustrating an example of a NACK-based scheme where NACK reception is unsuccessful, according to one or more embodiments of the present disclosure. As shown in FIG. 8, a (e.g., AIoT) device 304 may send a MSG1 transmission (e.g., indicating its RN ID) to a WTRU 102 (e.g., reader) at 802. At 804, the WTRU 102 may send a MSG2 (e.g., indicating the RN ID) to the device 304. At 806, the device 304 may send a MSG3 transmission (e.g., indicating its upper layer ID) which is not received by the WTRU 102. The WTRU 102 may send a NACK which is not received by the device 304 at 808.

After 808, the WTRU 102 may determine (e.g., assume) at 810a that the MSG3 transmitted at 806 was unsuccessful and expects to perform re-access at a later time.

After 806, the device 304 may wait for a (e.g., predefined or preconfigured) time period to receive a NACK from the WTRU 102 before determining at 810b that the MSG3 was successfully delivered to the WTRU 102. As the device 304 has not received the NACK sent at 808, the device 304 may wait to receive a command request message from the WTRU 102. As should be apparent in FIG. 8, the device 304 and the WTRU 102 encounter a problem due to the NACK failure at 808 where the device 304 and the WTRU 102 each assume a different outcome.

### Selection of Transmission Schemes Based on Conditions

In certain representative embodiments, a WTRU 102 may determine a transmission scheme (e.g., for feedback and/or retransmission) based on one or more conditions.

In certain representative embodiments, a WTRU 102 may receive an AIoT configuration for transmission schemes (e.g., transmission schemes for feedback and/or retransmission) from the network.

In certain representative embodiments, the AIoT configuration may include information indicating any of the following. For example, the AIoT configuration may include one or more conditions for transmission scheme selection, such as including one or more thresholds to determine transmission schemes (e.g., a feedback scheme and/or retransmission scheme). As examples, the thresholds may include any of a first threshold (e.g., for a D2R message size), a second threshold (e.g., for link quality, such as a RSRP, of the A-IoT interface), a third threshold (e.g., for a QoS), and/or a fourth threshold (e.g., for an energy or battery level). For example, the AoIT configuration may include an estimated size of D2R message(s). For example, the AoIT configuration may include whether a transmission scheme for feedback includes NACK-based and/or ACK-based schemes, and/or whether a transmission scheme for retransmission includes NDI-based or offset-based schemes.

In certain representative embodiments, a WTRU 102 may send a first transmission (e.g., a R2D transmission for RACH procedure triggering via a paging message) to one or more devices, such as upon receiving a paging message (e.g., service request) from a core network (CN). For example, the WTRU 102 may receive a paging message from the CN that includes one or more device IDs, one or more associated transmission schemes for feedback (e.g., NACK-based, ACK-based), one or more transmission schemes for retransmission (e.g., NDI-based, offset-based), and/or a QoS value (e.g., of the triggered service).

In certain representative embodiments, a WTRU 102 may receive one or more second transmission(s) (e.g., D2R messages with RN IDs) from the one or more devices.

In certain representative embodiments, a WTRU 102 may determines one or more transmission schemes (e.g., to be applied by the one or more devices) based on one or more (e.g., configured) conditions being satisfied. For example, if at least one condition is satisfied, the WTRU 102 may determine one or more first transmission schemes (e.g., NACK-based feedback scheme and/or offset-based retransmission scheme) should be applied by at least one of the devices.

For example, the WTRU 102 may determine a first transmission scheme if the (e.g., estimated) size of a D2R message (e.g., upper layer ID/data via MSG3) is below the first threshold.

For example, the WTRU 102 may determine a first transmission scheme if the measured A-IoT link quality (e.g., received RSRP via MSG1) is above the second threshold.

For example, the WTRU 102 may determine a first transmission scheme if the received QoS value (e.g., of the triggered service) is higher than the third threshold (e.g., a low priority service).

For example, the WTRU 102 may determine a first transmission scheme if the paging information from the CN includes an indication of the first transmission scheme (e.g., NACK-based and/or offset-based).

For example, the WTRU 102 may determine a first transmission scheme based on device type (e.g., type 1 and/or no memory) of the one or more devices.

For example, the WTRU 102 may determine a first transmission scheme if an energy level of the one or more devices is below the fourth threshold.

Otherwise (e.g., if none of the conditions are satisfied), the WTRU 102 may determine one or more second transmission schemes (e.g., ACK-based feedback scheme and/or NDI-based retransmission scheme) are applicable for the one or more devices.

In certain representative embodiments, a WTRU 102 may transmit a third (e.g., R2D) message that includes one or more of the received RN IDs and associated determined transmission schemes and/or an explicit indication (e.g., 1 bit) that indicates to reconfigure to the one or more determined transmission schemes.

In certain representative embodiments, a WTRU 102 may determine to configure feedback and retransmission schemes for D2R (re-)transmissions. Based on the solutions described herein, the WTRU 102 may achieve benefits with the selection of a transmission scheme considering the various conditions of at least one device.

As used herein, an AIoT device may refer to an IoT device powered by energy harvesting, such as a device with limited energy storage capability. An AIoT device may have other characteristics as well. Unless otherwise noted, the terms AIoT device, device, and tag may be used interchangeably, such as to refer to the A-IoT device that is being inventoried and/or queried by a WTRU 102 or network. For example, a WTRU 102 may refer to the entity which queries the A-IoT device, either directly, or via an intermediate WTRU such as in the second topology.

As used herein, an AIoT services may refer to the functionalities and procedures to support AIoT use cases.

As used herein, DO-DTT may refer to AIoT device originated traffic which is triggered by device-terminated traffic or signalling.

As used herein, DT may refer to traffic or signalling which is terminated at the AIoT device.

As used herein, the term WTRU or reader WTRU or intermediate node or I-node (e.g., in the second topology) may refer to the reader which refers to the entity which queries the A-IoT device. The term reader may refer to a network node or a WTRU 102, depending on the context and/or the topology. The term reader in the first topology may also refer to a network. In the first topology, the A-IoT device may directly communicates with network.

In the second topology, the A-IoT device communicates bidirectionally with an intermediate node between the device and base station. In this topology, the intermediate node may be a relay (e.g., layer-2/layer-3), IAB node, WTRU, repeater, or the like which is capable of A-IoT communication. The intermediate node may transfer A-IoT data and/or signaling between a base station and the A-IoT device.

As used herein, the terms RACH, RACH procedure, and RA may be used interchangeably to refer to an initial access procedure, random access, or RACH procedure (e.g., in an inventory procedure).

As used herein, the terms random number, RN, and RN 16 may be used interchangeably to refer to a RN ID in the RACH procedure (e.g., indicated in MSG1).

As used herein, the terms core network or CN may be used interchangeably to refer to a core network entity (e.g., A-IoT function server, AMF and/or NR core network).

As used herein, a query round may refer to the overall inventory procedure of a WTRU 102 triggering access by multiple devices using a sequence of messages. For example, an inventory procedure may refer to a single round of attempts to have each device respond or attempt to respond with its device ID or access ID. For example, an inventory procedure may refer to a set of access occasions which may have none or at least one device respond within the access occasion. For example, an inventory procedure may occur similar to legacy RFID procedures. Although referred to herein as an inventory procedure, it may be termed differently in device requirements or specifications (e.g., query procedure, paging procedure, RACH procedure, etc.).

### Overview

### Initial Access for Inventory Procedure

In certain representative embodiments, a WTRU 102 may perform initial access with at least one device 304 such as for an inventory procedure.

In certain representative embodiments, an initial access (e.g., RACH) procedure may be initiated with a device's first transmission during an access occasion (e.g., slot counter in random access RFID). Such transmission may be similar to the transmission by the device in a RFID inventory procedure to indicate the device ID. Such transmission may be followed by a confirmation of the device ID by the reader. Such transmission may be initiated by the device upon reception of an indication that an access occasion has been started. As with RFID, the indication of a start of an access occasion may be signaled in a message from the reader (e.g., in a Query or QueryAdjust or QueryRep message).

In certain representative embodiments, a device may initiate a RACH procedure (e.g., only) in a specific access occasion. The access occasions may be delimited by certain transmissions by the reader (e.g., similar to RFID where each QueryRep denotes the start of an occasion). In certain representative embodiments, a device may initiate a RACH procedure in multiple occasions. In certain representative embodiments, a device may initiate RACH in an occasion indicated by the reader in a Query message.

In certain representative embodiments, a device may perform a contention-based or contention free RACH procedure. In a contention free RACH procedure, the device may send a different set of information as compared to a contention-based RACH procedure. In a contention-based RACH procedure, the device may include its device ID while transmitting based on its access occasion. In one example, the device ID may be a number (e.g., 16-bit random number, 16-bit pseudo-random number, RN ID) and may transmit the device ID or number or RN ID via MSG1. In a contention-free RACH procedure, the device may include no device ID. Specifically, in implementations where the initial message which starts the occasion (e.g., the QueryRep or similar message) includes a device ID for that occasion, the device may initiate a contention free RACH procedure and may transmit any of the other configuration related information, or buffer status (e.g., without including a device ID).

### Command Procedure

In certain representative embodiments, a command procedure may be triggered by a WTRU 102.

In certain representative embodiments, a command procedure may be triggered by a WTRU 102 (e.g., reader) for one or more devices after an inventory procedure is completed (e.g., RACH procedure, paging and/or query procedure). For example, a WTRU 102 may trigger a command procedure for one or more devices after the one or more devices completed the inventory procedure. For example, the WTRU 102 may perform data communication with the device(s) via the A-IoT interface during a command procedure. For example, the WTUR 102 may send a command with an operation request (e.g., read, write) to one or more devices. For example, a read command may allow the WTRU 102 to read (e.g., all, a part of, portion of) the stored device information (e.g., memory, EPC memory, TID memory, etc.). For example, a write command may allow the WTRU 102 to write a word and/or information in a device's memory (e.g., memory, EPC memory, TID memory).

### Configuration and Associated Conditions

In certain representative embodiments, a WTRU 102 may receive configuration information.

In certain representative embodiments, a WTRU 102 may receive a configuration associated with feedback operation (e.g., ACK-based scheme or NACK-based scheme) and/or retransmission operation (e.g., offset-based scheme or NDI-based scheme) for one or more devices or one or more groups of devices upon receiving a D2R message (e.g., MSG3, MSG5, command response) from devices.

In certain representative embodiments, a WTRU 102 may receive a configuration associated with feedback operation and/or retransmission operation via a paging message, NAS message, and/or signaling from the CN. For example, the configuration may include an indication for the transmission scheme (e.g., NACK-based scheme, ACK-based scheme, offset-based scheme, and/or NDI-based scheme) which may be associated with one or more device IDs. For example, the indication with (e.g., at least) the configured transmission scheme may be associated and/or mapped to one device, multiple devices, or a group of devices to be configured using the transmission scheme.

In certain representative embodiments, a WTRU 102 may receive a configuration associated with feedback operation and related conditions (e.g., for scheme selection). For example, a (e.g., each) condition may be associated with triggering to send feedback (e.g., NACK) for a re-access operation or triggering to send feedback (e.g., ACK) for a confirmation of successful message reception from device(s). For example, the WTRU 102 may send a feedback indication with NACK, if at least one configured condition for a NACK-based scheme is satisfied (or if none of the conditions for an ACK-based scheme are satisfied). For example, the WTRU 102 may send a feedback indication with ACK, if at least one condition for ACK-based scheme is satisfied (or if none of the conditions for NACK-based scheme are satisfied).

In certain representative embodiments, a WTRU 102 may receive a configuration associated with retransmission of segmented D2R messages and related conditions. For example, a (e.g., each) condition may be associated with triggering to send a retransmission scheme (e.g., offset-based or NDI-based) for retransmission of segmented D2R data. For example, the WTRU 102 may send a request of retransmission with an offset-based scheme, if at least one configured condition for the offset-based scheme is satisfied (or if none of conditions for another scheme, such as a NDI-based scheme, are satisfied). For example, the WTRU 102 may send a request of retransmission with a NDI-based scheme, if at least one condition for the NDI-based scheme is satisfied (or if none of the conditions for another scheme, such as the offset-based scheme, are satisfied).

In certain representative embodiments, a WTRU 102 may receive a configuration associated with feedback operation and/or retransmission operation and related conditions via a broadcast and/or a unicast message from a base station. The WTRU 102 may receive the configuration via a broadcast message and/or dedicated message. For example, the configuration information may be received via a round initiated message, Query message, QueryAdjust message, QureyRep message, an RRC message, and/or SIB message. The WTRU 102 may receive the configuration information via a unicast message (e.g., SIB and/or RRC reconfiguration message).

Determining of Transmission Schemes based on Conditions

In certain representative embodiments, a WTRU 102 may determine at least one feedback and/or transmission scheme which is applicable to a device, multiple devices, or a group of devices based on one or more conditions.

As used herein, transmission of MSG3 and transmission of a command response or data by the device may be used interchangeably. As used herein, retransmission of a command by the reader and transmission of MSG2 (e.g., triggering MSG3 retransmission) by the reader may be used interchangeably.

In certain representative embodiments, a (e.g., reader) WTRU 102 may signal the (e.g., applicable) feedback and/or transmission scheme to a device, multiple devices, or a group of devices.

In certain representative embodiments, a (e.g., reader) WTRU 102 may configure a feedback and/or transmission scheme to one or more devices in an R2D message. For example, a reader may provide the transmission scheme (e.g., ACK-based or NACK-based) and/or retransmission scheme (e.g., offset-based or NDI-based) to the devices (e.g., explicitly) in a R2D message.

For example, the WTRU 102 may indicate the feedback and/or transmission scheme using an AIOT paging message. For example, the AIoT paging message may indicate the type of feedback and/or retransmission that can be sent by the reader upon transmission of data by the device. For example, the AIoT paging message may indicate that ACK only feedback is transmitted, that NACK only feedback is transmitted, or that the feedback is any of ACK or NACK.

For example, the WTRU 102 may indicate the feedback and/or transmission scheme using MSG2 of the AIoT random access procedure. For example, the reader may include an indication of the type of feedback and retransmission that can be sent by the reader in MSG2. For example, the reader may include, with each MSG1 random ID echoed by the reader, an indication of whether the reader intends to send an R2D message when MSG3 is received successfully, whether the reader intends to send an R2D message when MSG3 is not received successfully, whether the reader intends to send an R2D message whether MSG3 is received successfully or not, etc.

For example, the WTRU 102 may indicate the feedback and/or transmission scheme using a command request message. For example, the reader may indicate the type of feedback and/or retransmission that can be sent in the command request message itself. Specifically, the command request message sent to the device may indicate when the reader will respond with a message for the corresponding D2R message containing the requested data (e.g., upon successful D2R reception, upon unsuccessful D2R reception, etc).

For example, the WTRU 102 may indicate the feedback and/or transmission scheme using a sync message or occasion definition message. For example, the reader may indicate, in the R2D message which initiates the random access occasions, whether the specific occasion is associated with the reader providing feedback to successful MSG3 transmissions, providing feedback and retransmission to unsuccessful MSG3 transmissions, providing feedback in all cases, etc.

In certain representative embodiments, the transmission and/or retransmission schemes may be determined by a device and/or reader implicitly from another parameter or procedure. For example, the device may determine that feedback for ACK is transmitted for contention-based random access, while feedback for NACK is transmitted for contention-free random access (or vice versa). For example, the device may determine that feedback for ACK is transmitted for the first paging round associated with a transaction ID, while feedback for NACK is transmitted for subsequent paging rounds associated with a transaction ID. For example, a device may determine the transmission scheme based on the inclusion of a parameter (e.g., a timer) in an R2D message, or the value or range of such parameter.

In certain representative embodiments, a reader WTRU 102 may configure the retransmission signaling scheme in the same messages, or using the same mechanisms. For example, a reader WTRU 102 may indicate in the command request message, whether subsequent segments would be requested by the reader by providing an offset of the data in the R2D message, or indicating ACK/NACK only in the R2D message.

In certain representative embodiments, the transmission scheme may be changed upon a failure in transmission, or upon message transmission by the reader. For example, the transmission scheme may be initially assumed such that the reader transmits NACK upon MSG3 failure and does not transmit ACK upon success. Upon transmission of the first NACK following failure of MSG3 by a specific device, the reader may change to a second transmission scheme whereby the reader transmits either ACK or NACK explicitly following reception of MSG3. Specifically, if the first MSG3 transmitted by a device is received by the reader, the reader may not transmit any feedback. If the reader does receive MSG3 from a device, the reader may transmit NACK or may transmit MSG2. Following this, upon reception of MSG3 from the device, the reader may transmit ACK for successful receptions, and may transmit NACK for unsuccessful receptions.

### Device Signals Scheme to Reader

In certain representative embodiments, a device may signal the scheme to be used to the reader, such as based on device capability. For example, a device may signal the feedback and retransmission scheme to be used in MSG1. The signaling may be by inclusion of an explicit indication, by selection of a random ID in a configured range of values, and/or by selecting a specific range of configured access occasions for transmission of MSG1.

In certain representative embodiments, a device may determine its scheme based on device capability. For example, a device may determine its scheme based on remaining energy. As an example, if the remaining energy at the device is larger than a threshold, it may use or request ACK-based scheme, or vice versa. As an example, if the remaining energy at the device is larger than a threshold, it may use or request NDI-based scheme, or vice versa.

Determination of Feedback Scheme and/or Retransmission Scheme With Conditions

In certain representative embodiments, a WTRU 102 may determine whether to configure feedback operation with ACK-based scheme or NACK-based scheme upon detecting a failure of D2R reception.

For example, when a WTRU 102 selects and configures an ACK-based scheme, then reliability of D2R delivery may be increased because the WTRU 102 may send explicit feedback upon receiving a D2R message. For example, the WTRU 102 may select an ACK-based scheme when at least one condition for high reliability is satisfied (e.g., required high QoS and/or shorter D2R transmission coverage and/or low quality of A-IoT interface).

For example, when a WTRU 102 selects and configures a NACK-based scheme, then overhead of D2R transmission may be decreased because the WTRU 102 may not (e.g., always) send explicit feedback upon receiving a D2R message. For example, the WTRU 102 may select a NACK-based scheme when at least one condition for simplicity is satisfied (e.g., low QoS level, larger D2R transmission coverage and/or high quality of A-IoT interface).

In certain representative embodiments, a WTRU 102 may determine whether to configure retransmission operation with an offset-based scheme or a NDI-based scheme for a request of retransmission.

For example, when a WTRU 102 selects and configures a NDI-based scheme, then reliability of D2R consecutive delivery may be increased because the WTRU 102 may toggle the NDI value upon receiving a segmented D2R data via D2R message and request the retransmission with the NDI value for indicating that previous transmission for segmented D2R data was successful. Also, the device may have a storage memory to store and/or track the NDI value and memorize the value (e.g., 0 or 1). For example, the WTRU 102 may select a NDI-based scheme when at least one condition for high reliability is satisfied (e.g., device has memory and/or shorter D2R transmission coverage and/or low link quality of A-IoT interface).

For example, when a WTRU 102 may select and configure offset-based scheme, then overhead of D2R transmission may be decreased because the WTRU 102 (e.g., always) sends an explicit offset with a D2R grant of how many bits were received successfully and a device does not need to store or memorize the NDI value. For example, the WTRU 102 may select an offset-based scheme when at least one condition for simplicity is satisfied (e.g., no memory, larger D2R transmission coverage and/or high link quality of A-IoT interface).

In certain representative embodiments, a WTRU 102 may determine transmission schemes (e.g., ACK-based scheme, NACK-based scheme, offset-based scheme, NDI-based scheme) and may configure a device when at least one of the (e.g., configured) conditions is satisfied. In certain representative embodiments, (e.g., any of) the conditions may be based on any of the following.

In certain representative embodiments, a WTRU 102 may use a size of a D2R message. In one example, a WTRU 102 may determine and configure feedback scheme and/or retransmission scheme to one or more devices based on the size of the D2R message (e.g., MSG3 and/or MSG5 and/or D2R data message and/or command response message). For example, if the size of the D2R message is less than the configured threshold (e.g., number of bits or bytes), a WTRU 102 may determine to configure a NACK-based feedback scheme and/or an offset-based retransmission scheme to one or more devices. For example, if the size of the D2R message is greater than the configured threshold (e.g., number of bits or bytes), a WTRU 102 may determine to configure an ACK-based feedback scheme and/or a NDI-based retransmission scheme to one or more devices.

In certain representative embodiments, a WTRU 102 may use an A-IoT measurement. In one example, a WTRU 102 may determine and configure a feedback scheme and/or retransmission scheme to one or more devices based on the quality of the A-IoT link with measurement results (e.g., RSSP, RSRQ, and/or RSSI values). For example, if the measurement results of the A-IoT link are higher than the configured threshold (e.g., RSSP, RSRQ, and/or RSSI values), a WTRU 102 may determine to configure a NACK-based feedback scheme and/or an offset-based retransmission scheme to one or more devices. For example, if the measurement results of the A-IoT link are less than the configured threshold (e.g., RSSP, RSRQ, and/or RSSI values), the WTRU 102 may determine to configure an ACK-based feedback scheme and/or a NDI-based retransmission scheme to one or more devices.

In certain representative embodiments, a WTRU 102 may use a QoS level (e.g., priority). As an example, the QoS value (e.g., priority) may be set between 1 to 16. As an example, the lowest value/number (e.g., 1) may correspond to the highest priority. The highest value/number (e.g., 16) may correspond to the lowest priority.

In one example, a WTRU 102 may determine and configure a feedback scheme and/or retransmission scheme to one or more devices based on the received QoS level of the triggered service (e.g., QoS value). The WTRU 102 may receive the QoS value from the CN, such as via a paging message and/or NAS message. For example, if the received QoS value is higher than a configured threshold (e.g., lower priority), a WTRU 102 may determine to configure a NACK-based feedback scheme and/or offset-based retransmission scheme to one or more devices.

For example, if the received QoS value is lower than the configured threshold (e.g., higher priority), the WTRU 102 may determine to configure an ACK-based feedback scheme and/or NDI-based retransmission scheme to one or more devices.

In certain representative embodiments, a WTRU 102 may use a device type and/or a device status. In one example, a WTRU 102 may determine and configure a feedback scheme and/or retransmission scheme to one or more devices based on the device type and/or a capability (e.g., memory) status. The WTRU 102 may receive device information (e.g., device type and/or device status) via capability signaling from the device and/or the CN. For example, if the capability of a device is high (e.g., backscattering with power boosting and/or active transmission and/or repetition and/or device type 2a or 2b and/or having a memory and/or storage for pending segmentation and/or having an UL buffer and energy storage), a WTRU 102 may determine to configure an ACK-based feedback scheme and/or NDI-based retransmission scheme to the device. For example, if the capability of device is low (e.g., backscattering and/or device type 1 and/or no memory and/or no repetition capability and/or no UL buffer and/or no energy storage), a WTRU 102 may determine to configure a NACK-based feedback scheme and/or offset-based retransmission scheme to the device.

In certain representative embodiments, a WTRU 102 may use an energy level. In one example, a WTRU 102 may determine and configure a feedback scheme and/or retransmission scheme to one or more devices based on energy level of the device (e.g., remaining time before performing energy harvesting or going to sleep cycle or state). For example, the WTRU 102 may determine the feedback scheme based on the energy level of the device upon receiving an energy status report from at least one device. The energy status report may indicate the status of an energy level of a device (e.g., high, medium, low or remaining active time, such as in slots, milliseconds, seconds, hours). For example, if the energy level is higher than the configured threshold (e.g., remaining active time duration, such as milliseconds, seconds, hours), a WTRU 102 may determine to configure a NACK-based feedback scheme and/or offset-based retransmission scheme to one or more devices. For example, if the energy status is lower than the configured threshold (e.g., remaining active time duration, such as milliseconds, seconds, hours), a WTRU 102 may determine to configure an ACK-based feedback scheme and/or NDI-based retransmission scheme to one or more devices.

In certain representative embodiments, a WTRU 102 may use mobility information. In one example, a WTRU 102 may determine and configure a feedback scheme and/or retransmission scheme to one or more devices based on device mobility (e.g., whether the device is mobile or stationary). The WTRU 102 may receive the mobility information of device based on the reported capability information from the device and/or device assistance information from the CN. For example, if a device is determined to be stationary and/or a stationary device, a WTRU 102 may determine and configure a NACK-based feedback scheme and/or offset-based retransmission scheme to the device. For example, if a device is determined to be mobile and/or not a stationary device, a WTRU 102 may determine and configure an ACK-based feedback scheme and/or NDI-based retransmission scheme to the device.

In certain representative embodiments, a WTRU 102 may use a combination of the foregoing factors. In certain representative embodiments, a WTRU 102 may use a combination of multiple conditions to determine the feedback scheme and/or retransmission scheme. In certain representative embodiments, a WTRU 102 may determine a threshold for a condition based on (e.g., computed from) another factor.

Configuration for Determined Feedback Scheme and/or Retransmission Scheme

In certain representative embodiments, a WTRU 102 may determine a transmission scheme for feedback operation (e.g., NACK-based or ACK-based), and a transmission scheme for retransmission (e.g., NDI-based or offset-based). Upon determining the transmission scheme for a device, a WTRU 102 may transmit the determined scheme via a R2D message (e.g., via MSG2, command request message, sync message) to the device. For example, the determined scheme may be configured for one or more devices. For example, the WTRU 102 may configure the determined transmission scheme to one or more devices and/or a subgroup of devices. For example, the WTRU 102 may configure the determined transmission scheme and the associated RN IDs (e.g., of the subgroup of devices) via MSG2.

In certain representative embodiments, a WTRU 102 may configure an explicit indication (e.g., 1 bit) for the reconfiguration of the transmission schemes (e.g., reconfigure as “1” or maintain as “0”). For example, upon receiving a value of “1” (e.g., reconfiguration), a device may change and/or update from a NACK-based (or ACK-based) scheme to an ACK-based (or NACK-based) scheme for feedback operation and/or a device may change and/or update from an offset-based (or NDI-based) scheme to a NDI-based (or offset-based) scheme for retransmission operation. For example, upon receiving a value of “0” (e.g., maintain or keep), a device may maintain the current feedback operation (e.g., NACK-based or ACK-based) and/or a device may maintain the current retransmission operation (e.g., offset-based or NDI-based).

### Example Flow

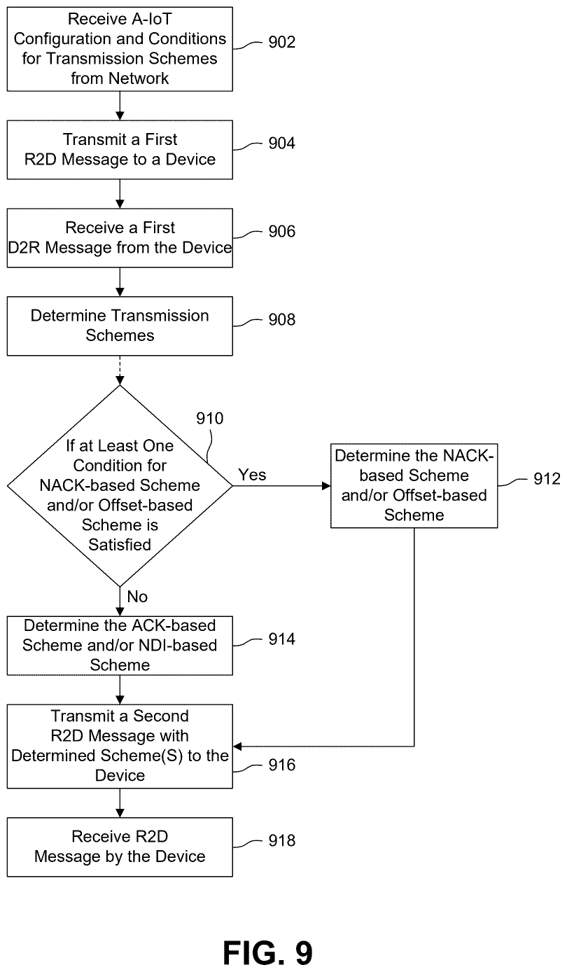

FIG. 9 is a flow diagram illustrating an example flow to configure a device with a feedback scheme and a retransmission scheme, according to one or more embodiments of the present disclosure. As shown in FIG. 9, a (e.g., reader) WTRU 102 may receive a configuration including a set of A-IoT transmission schemes and associated conditions for feedback and/or retransmission from a network at 902. At 904, the WTRU 102 may transmit a first R2D message to a (e.g., AIoT) device(s). At 906, the WTRU 102 may receive a first D2R message (e.g., MSG1) from the device.

At 908, the WTRU 102 may determine transmission schemes for feedback (e.g., ACK-based or NACK-based) and retransmission (e.g., offset-based or NDI-based) for the device. For example, the WTRU 102 may determine whether or not at least one of the configured conditions for the (e.g., configured) NACK-based and/or offset-based scheme is satisfied at 910. If at least one of the configured conditions for the (e.g., configured) NACK-based and/or offset-based scheme is determined to be satisfied at 910, the WTRU 102 may determine a NACK-based and/or offset-based scheme at 912. If none of the conditions are satisfied, the WTRU 102 may determine an ACK-based and/or NDI-based scheme at 914.

At 916, the WTRU 102 may send a second R2D message (e.g., MSG2, paging message) to the device. For example, the second R2D message may include information indicating the determined transmission schemes which are applicable for the device. At 918, upon receiving the second R2D message from the WTRU 102, the device may configure the indicated transmission schemes for feedback and/or retransmission.

### Determination of Re-Access Based on Timer Information

In certain representative embodiments, a (e.g., AIoT) device may determine to perform a re-access procedure upon lapsing of one or more time intervals (e.g., expiry of one or more timers) in a NACK-based scheme. For example, if the feedback delivery (e.g., NACK) is failed to a device, there may be no way to know at both the device and WTRU 102 that the feedback transmission failure has occurred. Once the feedback delivery is failed, a device may wait for a command request message which assumed that delivery was successful due to the absence of a received NACK. For example, the WTRU 102 may expect the device to perform a re-access procedure upon transmitting the feedback of NACK to the device. However, the device may not perform re-access as it does not successfully receive the NACK message from the WTRU 102.

In certain representative embodiments, a device (e.g., triggered inventory and command procedure) may receive a configuration indicating information associated with one or more timer values and/or time windows. The device may receive a configuration of one or more timer values (e.g., a first timer value and/or second timer value) from the WTRU 102 for receiving feedback and command request for inventory and command procedure. For example, the first timer value and the second timer value may set a same value (e.g., time interval) or may set the different values (e.g., intervals) or may run a single timer (e.g., time interval) with one time value (e.g., including the first and second timer values, such as a sum thereof).

For example, upon transmitting a D2R message (e.g., MSG3), the device may run a first timer (e.g., set a first time interval) to receive feedback (e.g., NACK). Upon expiry of the first timer (e.g., interval), a device may run a second timer (e.g., set a second time interval) to receive a command request message. Upon expiry of the second timer, the device may determine to perform a re-access procedure based on the transmitted feedback having failed to deliver.

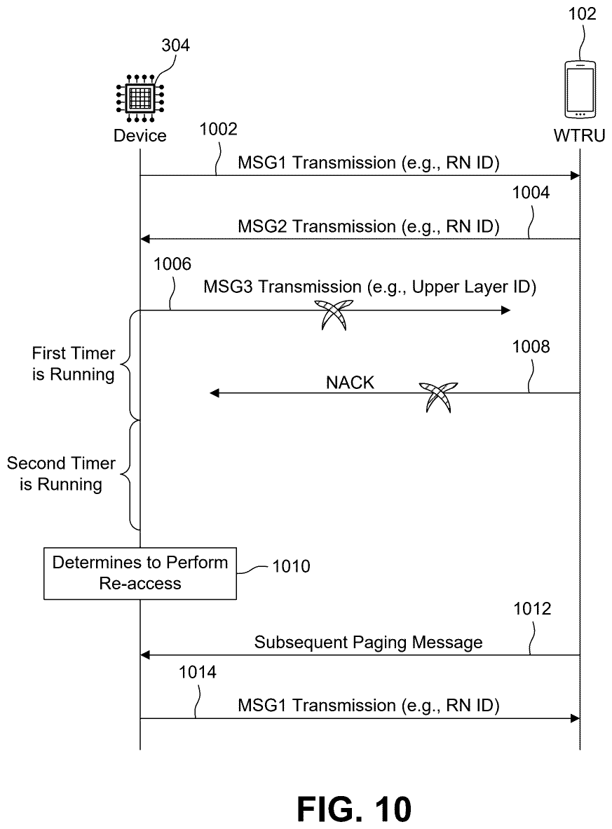

FIG. 10 is a signaling diagram illustrating an example where NACK feedback has failed, according to one or more embodiments of the present disclosure. As shown in FIG. 10, a device 304 may send a MSG1 (e.g., indicating a RN ID) to the WTRU 102 at 1002. At 1004, the WTRU 102 may send a MSG2 (e.g., indicating the RN ID) to the device 304. At 1006, the device may send a MSG3 (e.g., indicating upper layer ID) to the WTRU 102. For example, the device may use the transmission of MSG3 as a start of a first timer (e.g., beginning of a first time interval). For example, the WTRU 102 may not receive the MSG3 transmission and/or the device 304 may not receive a NACK sent from the WTRU 102 at 1008. After the first time expires (e.g., end of the first time interval), and the device 304 may assume that MSG3 delivery was successful (e.g., no NACK reception) or NACK delivery has failed. The device 304 may start a second timer (e.g., beginning of a second time interval) and device may wait to receive a command request (e.g., a subsequent step after successful RACH/inventory procedure). At the expiry of the second timer (e.g., end of the second time interval), the device 304 may determine to perform re-access at 1010 (e.g., assuming no command request was received before the expiry of the second timer). The device 304 may assume that NACK delivery has failed (or MSG3 delivery has failed) implicitly upon expiry of the second timer. If the WTRU 102 receives MSG3 successfully, then the WTRU 102 may send a command request to the device 304 while the second timer is running.

At 1012, the WTRU 102 may send a subsequent paging message to the device 304. At 1014, the device 304 may send another MSG1 (e.g., indicating a RN ID) to the WTRU 102.

Additional Paging Message with Conditions

In certain representative embodiments, a WTRU 102 may send a R2D message (e.g., subsequent paging message, QueryRep message, inventory request message) to one or more devices including one or more indications. The WTRU 102 may receive a R2D message from the CN (e.g., paging message). For example, one or more indications may be provided in the received R2D message from CN. For example, the one or more indications may be included by WTRU 102 in R2D messaging to the devices.

In certain representative embodiments, a subsequent R2D message (e.g., paging message) may include one or more indications. For example, an indication may indicate to the device 304 to perform re-access, such as if a device does not receive first feedback (e.g., NACK via MSG4/feedback) in a previous (or current) paging round. For example, an indication may indicate to the device 304 to perform re-access, such as if a device does not receive second feedback (e.g., ACK via MSG4/feedback) in the previous (or current) paging round. For example, an indication may indicate to perform re-access, such as if a device 304 performs (e.g., expects) feedback with a NACK-based scheme or ACK-based scheme.

Determination of ACK with Subsequent Messaging

In certain representative embodiments, a device 304 may determine that a previous D2R transmission is successful upon receiving a command request in an ACK-based feedback scheme. For example, upon receiving the D2R message (e.g., MSG3) from a device, the WTRU 102 may send a command request message with skipping feedback (e.g., ACK feedback) to the device 304. Upon receiving the command request message, the device 304 may determine (e.g., assume) that the previous delivery of the D2R message (e.g., MSG3) was successful based on the subsequent command request message (e.g., command request message with skipping feedback). For example, the command request message may include ACK feedback (e.g., implicitly).

In certain representative embodiments, upon transmitting a command response to a WTRU 102, a device 304 may receive a subsequent response message(s) from a WTRU 102. Upon receiving a subsequent command request (e.g., triggering another subsequent command procedure), the device 304 may determine (e.g., assume) that the previous D2R message (e.g., command response) was delivered successfully.

### Representative Procedures

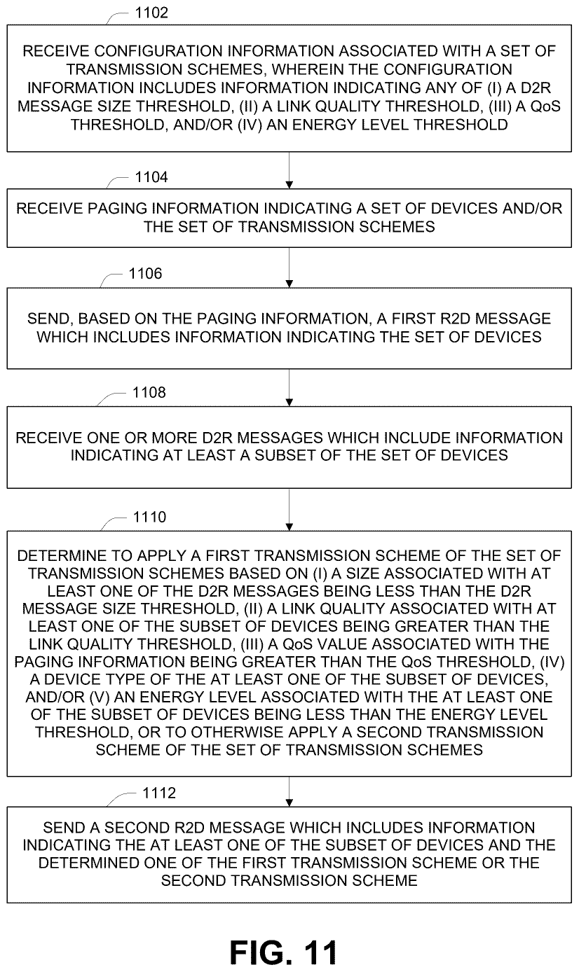

FIG. 11 is a procedural diagram illustrating an example procedure for determining a transmission scheme for one or more devices, according to one or more embodiments of the present disclosure. As shown in FIG. 11, a WTRU 102 may receive configuration information associated with a set of transmission schemes at 1102. For example, the configuration information may include information indicating any of (i) a D2R message size threshold, (ii) a link quality threshold, (iii) a QoS threshold, and/or (iv) an energy level threshold. At 1104, the WTRU 102 may receive paging information indicating a set of devices 304 and/or the set of transmission (e.g., feedback and/or retransmission) schemes. At 1106, the WTRU 102 may send, based on the paging information, a first R2D message which includes information indicating the set of devices 304 (e.g., to each of the set of devices). At 1108, the WTRU 102 may receive one or more D2R messages (e.g., from one or more of the paged devices) which include information indicating at least a subset of the set of devices 304. For example, a (e.g., each) D2R message may include an identifier (e.g., RN ID) of a respective paged device 304. At 1110, the WTRU 102 may determine to apply a first transmission scheme of the set of transmission schemes based on (i) a size associated with at least one of the D2R messages being less than the D2R message size threshold, (ii) a link quality associated with at least one of the subset of devices being greater than the link quality threshold, (iii) a QoS value associated with the paging information being greater than the QoS threshold, (iv) a device type of the at least one of the subset of devices, and/or (v) an energy level associated with the at least one of the subset of devices being less than the energy level threshold, or to otherwise apply a second transmission scheme of the set of transmission schemes. At 1112, the WTRU 102 may send a second R2D message (e.g., to a respective paged device) which includes information indicating the at least one of the subset of devices and the determined one of the first transmission scheme or the second transmission scheme.

In certain representative embodiments, the set of devices may include (e.g., a set of) ambient internet of things (A-IoT) devices.

In certain representative embodiments, the paging information (e.g., from the CN) may indicate a QoS value associated with a service triggered by the paging information.

In certain representative embodiments, the first R2D message may include information (e.g., indicating) to trigger the set of devices to (e.g., each) perform a random access procedure.

In certain representative embodiments, the one or more D2R messages may include MSG1 transmissions from the subset of the set of devices.

In certain representative embodiments, the one or more D2R messages may include MSG3 transmissions from the subset of the set of devices.

In certain representative embodiments, the size associated with at least one of the D2R messages may be an amount of uplink data carried via a MSG3 transmission.

In certain representative embodiments, the link quality associated with at least one of the subset of devices may be a RSRP of a MSG1 transmission.

In certain representative embodiments, the first transmission scheme may include (e.g., be) a NACK-based transmission scheme and/or an offset-based retransmission scheme.

In certain representative embodiments, the second transmission scheme may include (e.g., be) an ACK-based transmission scheme and/or a NDI-based retransmission scheme.

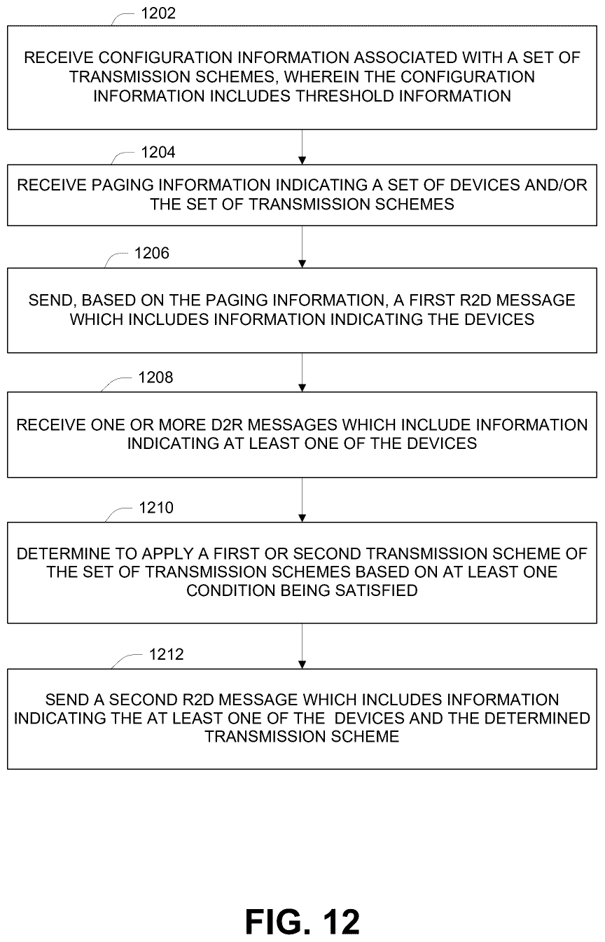

FIG. 12 is a procedural diagram illustrating another example procedure for determining a transmission scheme for one or more devices, according to one or more embodiments of the present disclosure. As shown in FIG. 12, a WTRU 102 may receive configuration information associated with a set of transmission schemes at 1202. For example, the configuration information may include threshold information (e.g., a first threshold, a second threshold, and so forth). At 1204, the WTRU 102 may receive paging information indicating a set (e.g., group) of devices and/or the set of transmission schemes. At 1206, the WTRU 102 may send, based on the paging information, a first R2D message which includes information indicating the devices. At 1208, the WTRU 102 may receive one or more D2R messages which include information indicating one or more of the devices. For example, one D2R message may include an identifier (e.g., RN ID) of one of the (e.g., paged) devices. At 1210, the WTRU 102 may determine to apply a first or second transmission scheme of the set of transmission schemes based on at least one condition being satisfied. Various examples of conditions that may be used by the WTRU are provided herein. At 1212, the WTRU 102 may send a second R2D message which includes information indicating the at least one of the devices (e.g., which were responsive at 1208) and the determined transmission scheme.

The procedure illustrated in FIG. 12 may be altered, modified, and/or combined with various features as described throughout this disclosure.

### References

The content of each of the following references is incorporated by reference herein in its entirety:

Third generation partnership project (3GPP), RP-234058, New SID, Study on solutions for Ambient IoT (Internet of Things) in NR;
Electronic Product Code (EPC), Radio-Frequency Identity Protocols Generation-2 UHF RFID;
3GPP, TR 38.769, Study on solutions for Ambient IoT (Internet of Things) in NR, V 19.0.0 (Jan. 2025); and
3GPP, TR 22.840, Study on Ambient power-enabled Internet of Things, V 19.0.0 (Dec. 2023).

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. A wireless transmit/receive unit (WTRU) comprising:
a processor, memory, and a transceiver which are configured to:
receive configuration information associated with a set of transmission schemes, wherein the configuration information includes information indicating any of (i) a device to reader (D2R) message size threshold, (ii) a link quality threshold, (iii) a quality of service (QoS) threshold, and/or (iv) an energy level threshold,
receive paging information indicating a set of devices and/or the set of transmission schemes,
send, based on the paging information, a first reader to device (R2D) message which includes information indicating the set of devices,
receive one or more D2R messages which include information indicating at least a subset of the set of devices,
determine to apply a first transmission scheme of the set of transmission schemes based on (i) a size associated with at least one of the D2R messages being less than the D2R message size threshold, (ii) a link quality associated with at least one of the subset of devices being greater than the link quality threshold, (iii) a QoS value associated with the paging information being greater than the QoS threshold, (iv) a device type of the at least one of the subset of devices, and/or (v) an energy level associated with the at least one of the subset of devices being less than the energy level threshold, or to otherwise apply a second transmission scheme of the set of transmission schemes, and
send a second R2D message which includes information indicating the at least one of the subset of devices and the determined one of the first transmission scheme or the second transmission scheme.

2. The WTRU of claim 1, wherein the set of devices are ambient internet of things (A-IoT) devices.

3. The WTRU of claim 1, wherein the paging information indicates a QoS value associated with a service triggered by the paging information.

4. The WTRU of claim 1, wherein the first R2D message includes information to trigger the set of devices to perform a random access procedure.

5. The WTRU of claim 1, wherein the one or more D2R messages include MSG1 transmissions from the subset of the set of devices.

6. The WTRU of claim 1, wherein the one or more D2R messages include MSG3 transmissions from the subset of the set of devices.

7. The WTRU of claim 1, wherein the size associated with at least one of the D2R messages is an amount of uplink data carried via a MSG3 transmission.

8. The WTRU of claim 1, wherein the link quality associated with at least one of the subset of devices is a reference signal received power (RSRP) of a MSG1 transmission.

9. The WTRU of claim 1, wherein the first transmission scheme includes a negative acknowledgment-based (NACK-based) transmission scheme and/or an offset-based retransmission scheme.

10. The WTRU of claim 1, wherein the second transmission scheme includes an acknowledgment-based (ACK-based) transmission scheme and/or a new data indicator-based (NDI-based) retransmission scheme.

11. A method implemented by a wireless transmit/receive unit (WTRU), the method comprising:
receiving configuration information associated with a set of transmission schemes, wherein the configuration information includes information indicating any of (i) a device to reader (D2R) message size threshold, (ii) a link quality threshold, (iii) a quality of service (QoS) threshold, and/or (iv) an energy level threshold;
receiving paging information indicating a set of devices and/or the set of transmission schemes;
sending, based on the paging information, a first reader to device (R2D) message which includes information indicating the set of devices;
receiving one or more D2R messages which include information indicating at least a subset of the set of devices;
determining to apply a first transmission scheme of the set of transmission schemes based on (i) a size associated with at least one of the D2R messages being less than the D2R message size threshold, (ii) a link quality associated with at least one of the subset of devices being greater than the link quality threshold, (iii) a QoS value associated with the paging information being greater than the QoS threshold, (iv) a device type of the at least one of the subset of devices, and/or (v) an energy level associated with the at least one of the subset of devices being less than the energy level threshold, or to otherwise apply a second transmission scheme of the set of transmission schemes; and
sending a second R2D message which includes information indicating the at least one of the subset of devices and the determined one of the first transmission scheme or the second transmission scheme.

12. The method of claim 11, wherein the set of devices are ambient internet of things (A-IoT) devices.

13. The method of claim 11, wherein the paging information indicates a QoS value associated with a service triggered by the paging information.

14. The method of claim 11, wherein the first R2D message includes information to trigger the set of devices to perform a random access procedure.

15. The method of claim 11, wherein the one or more D2R messages include MSG1 transmissions from the subset of the set of devices.

16. The method of claim 11, wherein the one or more D2R messages include MSG3 transmissions from the subset of the set of devices.

17. The method of claim 11, wherein the size associated with at least one of the D2R messages is associated with an amount of uplink data carried via a MSG3 transmission.

18. The method of claim 11, wherein the link quality associated with at least one of the subset of devices is associated with a reference signal received power (RSRP) of a MSG1 transmission.

19. The method of claim 11, wherein the first transmission scheme includes a negative acknowledgment-based (NACK-based) transmission scheme and/or an offset-based retransmission scheme.

20. The method of claim 11, wherein the second transmission scheme includes an acknowledgment-based (ACK-based) transmission scheme and/or a new data indicator-based (NDI-based) retransmission scheme.
